(19) United States
(12) Patent Application Publication
(10) Pub. No.: US 2007/0003672 A1
(43) Pub. Date: Jan. 4, 2007

(54) Tri-part calcium fortified compositions and methods of making the same

(76) Inventors: Timothy A. Anglea, Apopka, FL (US); Andrew P. Ericson, Lakeland, FL (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/171,314

(22) Filed: Jul. 1, 2005

(51) Int. Cl. A23L 1/30

(52) U.S. Cl. 426/74

(57) ABSTRACT

The present disclosure relates to a composition comprising (a) a calcium combination consisting essentially of tricalcium phosphate, monocalcium phosphate and calcium lactate, and (b) a juice. The present disclosure further relates to a method of fortifying a beverage comprising preparing a calcium combination consisting essentially of tricalcium phosphate, monocalcium phosphate and calcium lactate; and combining the calcium combination and a juice.

The present disclosure relates to a composition comprising (a) a calcium combination consisting essentially of tricalcium phosphate, monocalcium phosphate and calcium lactate, and (b) a juice. The present disclosure also relates to a method for balancing sweetness and tartness associated with juices comprising: preparing a calcium combination consisting essentially of tricalcium phosphate, monocalcium phosphate and calcium lactate; and adding the calcium combination to a juice.

Calcium is the most abundant component of minerals present in the human body, comprising approximately two percent of total body weight. Calcium is continuously utilized by the body and is replenished by a variety of food sources. The body's use of calcium includes providing rigidity to the skeletal framework; serving as a catalyst for the conversion of prothrombin to thrombin, a compound necessary for blood clotting; increasing cell membrane permeability; activating a number of enzymes including lipase and adenosine triphosphatase; and acting as a component in the mechanisms of neural transmission and muscular contraction.

Given these representative vital usages of calcium by the body, it is recognized that a dietary calcium deficiency can have adverse effects on an individual's health, which vary in degree depending upon age and sex. For example, calcium deficiency can interfere with muscular contraction and can also result in depletion of skeletal calcium, resulting in thin and brittle bones.

This latter malady is known as osteoporosis. Osteoporosis (porous bones) is a deficiency disease, a condition in which there is varying degrees in the loss of bone density or actual bone loss. Adult bone loss is considered one of the most debilitating health problems for elderly people. Although bone loss occurs in both men and women as they age, women suffer more often and with more devastating effects. This is due in part to the fact that women, in general, have smaller skeletal structures than men and also undergo accelerated bone loss at menopause due to estrogen loss. This crippling disease affects approximately one out of four women over the age of 60. The bones become more susceptible to breaks; repeat fractures have a lower chance of healing, which often leads to fatal complications.

Several studies conducted in recent years have shown that increased dietary intake of calcium may be effective in minimizing bone loss in elderly or post menopausal women. It is thought that increased consumption of calcium in early years builds reserves that enable a greater tolerance of a negative calcium balance in later years.

Foods fortified with calcium and calcium supplements are being used more often by the U.S. consumer and are generally considered by some researchers to offer the same net effect as calcium naturally found in food. The most effective order of relative bioavailability or intestinal absorption of various calcium salts is still controversial. There is no consensus among medical authorities as to the effectiveness of one calcium salt over another.

Nevertheless, there are several known factors that affect the absorption of calcium by the human body. In healthy adults approximately 30 percent of calcium contained in their diets is absorbed. The absorption of calcium from various foods may range from 10% to 40%. Generally, at very high intake levels the efficiency of the absorption process decreases. The body's need is probably the most significant factor in controlling this absorption process through feedback mechanisms. Children and pregnant/lactating women absorb an average of 40% of the calcium in their diets.

Acid solutions enhance the solubility of calcium salts. Much of the digestion of food takes place in the duodenum where the pH of the gastric juices is low. Since calcium salts are more soluble in an acid pH, much of the absorption of calcium takes place in this segment of the gastrointestinal tract. Tricalcium phosphate, calcium lactate, calcium carbonate and many other calcium compounds have all been used as calcium sources in various calcium fortified products. In “Nutrition and Metabolic Bone Disease With A Special Emphasis On The Role Of Calcium”, Pak, C. Y. C., Medical Grand Rounds, Southwestern Medical School, Mar. 6, 1986, it is disclosed that calcium citrate is the preferred salt for calcium fortification in certain juices. Several commercially available products such as antacids disclose the use of calcium carbonate as a dietary calcium supplement.

The recommended daily allowance (RDA) now termed the “recommended daily intake” (RDI) of a mineral is the gender-specific recommendation considered by scientific experts to be adequate to meet the need for that nutrient for virtually all healthy people in the population and set forth in the Recommended Daily Dietary Allowance-Food & Nutrition Board, National Academy of Sciences-National Research Counsel. The current RDI of calcium is 500 to 800 mg/day for children depending on age. The RDI for teenagers is 1300 mg/day and is from 1000 to 1200 mg/day for adults. Pregnancy and lactation increase the recommended amount by about 400 mg per day. The U.S. RDIs are derived from the 1968 RDA and are standards specified by the Food and Drug Administration to simplify nutritional labeling.

Dairy products are recognized as a rich source of dietary calcium, in some instances accounting for as much as 75% of an individual's dietary intake of calcium. Increased ingestion of dairy products, however, has several drawbacks, which preclude their broad recommendation as a solution for dietary calcium deficiency. These drawbacks include lactose intolerance by some individuals; the high levels of cholesterol and cholesterol producing ingredients in dairy products; the high caloric yields of dairy products; and flavor off-tastes often experienced by elderly individuals.

Various beverages exist which contain a calcium component in amounts which vary depending upon the purpose of the calcium additive.

U.S. Pat. No. 3,227,562 (“the '562 patent”), which is hereby incorporated by reference, discloses a citrus fruit juice concentrate having a low Brix to acid ratio. As disclosed in the '562 patent, the Brix unit is a commonly used unit of measurement which expresses the concentration of dissolved solids in an aqueous solution. The acid unit represents the citric acid concentration in the citrus juice. The Brix to acid ratio is the accepted measurement of the sweetness to tartness ratio used in the fruit juice industry. A Brix-acid ratio is obtained by dividing the Brix value by the acid value for a given product, which yields a ratio compared with unity, which forms a comparative scale for acceptability for particular juice concentrates. Brix-acid ratios of concentrated citrus fruit juice, e.g., high grade fresh-frozen orange juice concentrate, will usually have a range of Brix-acid ratios of about 12.5:1 to about 20:1, whereas a range for grapefruit juice would be about 7:1 to about 11:1. Brix-acid ratios for commercially available citrus fruit juice-containing drinks generally range from 17:1 to 54:1. High quality commercially available orange juice products usually have a Brix-acid ratio range of 16:1 or higher.

The '562 patent attributes the characteristic aftertaste of its concentrate to a combination of salts comprising sodium chloride, magnesium chloride, calcium chloride and sodium silicate with a citrus concentrate comprised of orange, lemon grapefruit, and lime. The level of calcium chloride contained in the concentrate of the '562 patent is in the range of 3 mg per 6 ounce serving with the bulk of the salt used to impart the pleasant aftertaste consisting of sodium chloride.

U.S. Pat. No. 4,871,554 describes a calcium fortified juice beverage with a calcium source from tribasic calcium phosphate and calcium lactate. From this blend, about 65% to 75% of the calcium is from calcium phosphate and about 25% to 35% is from calcium lactate. While the blend of tricalcium phosphate and calcium lactate is utilized, other combinations of calcium salts, however, are often described as adding a hard character to the flavor of the beverage.

U.S. Pat. No. 5,474,793 describes a calcium fortification process for ready-to-drink not-from-concentrate fruit juice beverages made by mixing a not-from-concentrate juice stream including citric and malic acid with a powdered calcium source. The powdered calcium source primarily is composed of calcium hydroxide but minor amounts of other calcium salts may be added, e.g., calcium carbonate, calcium oxide, calcium chloride, calcium citrate, calcium gluconate, calcium lactate, calcium phosphate, calcium sulfate and mixtures thereof. Likewise, U.S. Patent Application Publication No. 2002/0102331 discloses a calcium fortified beverage composition including a calcium source from a blend of calcium salts comprising calcium chloride and at least two additional calcium salts chosen from monocalcium phosphate, calcium carbonate, and calcium hydroxide. According to this publication, calcium hydroxide, calcium carbonate and calcium chloride provided better tasting beverages compared with a blend of calcium hydroxide and calcium chloride alone or calcium carbonate and calcium chloride alone. Other blended calcium sources are suggested including monocalcium phosphate, calcium hydroxide and calcium chloride or monocalcium phosphate, calcium carbonate, calcium hydroxide, and calcium chloride.

As such, it is evident that there are many calcium sources, for example, inorganic salts such as calcium phosphate and organic salts such as tricalcium citrate, calcium lactate and calcium gluconate. The use of one of these calcium sources and/or a combination thereof may be based on the properties associated with each, the type of composition, the desired calcium content, the resulting taste, the stability and solubility of the calcium components in the composition, and/or the bioavailability of the calcium source in the beverage composition.

Attempts to fortify composition, e.g., beverages with various calcium compounds, however, experience some problems such as the calcium salts may disrupt the sweetness-tartness ratio often measured and expressed as the Brix-acid ratio. To compensate for such an imbalance, the amount of dissolved solids may be increased to raise the Brix value and/or the amount of acidic or basic salts may be adjusted to influence the acidity of the beverage composition. Further complications may arise when a fruit and/or vegetable crop experiences a natural decline in acidity and/or another intrinsic property due to climatic or other extenuating circumstances that alters the naturally occurring properties of the juice component.

Flavor defects are also not uncommon when fortifying compositions such as beverages with calcium. For example, some of the organic and inorganic salts used for fortification add taste defects such as chalkiness, grittiness, or tangy tastes and/or even a bitter after-taste based on the use of one or a combination of calcium sources.

Consequently, it is desirable to develop a calcium fortified composition, e.g., an edible food product or a beverage, which reduces and/or eliminates at least one of the above-mentioned problems in the art. In one aspect, the present disclosure is directed to a composition comprising (a) a calcium combination consisting essentially of tricalcium phosphate, monocalcium phosphate and calcium lactate, and (b) a juice. For example, the composition is in a form chosen from an edible food product and a beverage.

In another aspect, the present disclosure is directed to a method for balancing sweetness and tartness associated with juices comprising: preparing a calcium combination consisting essentially of tricalcium phosphate, monocalcium phosphate and calcium lactate; and adding the calcium combination to a juice.

It is to be understood that both the foregoing general description and the following detailed description are exemplary and explanatory only and are not restrictive of the present disclosure, as claimed. These and other advantages are realized by the present disclosure, which comprises methods and compositions of matter, which substantially avoid at least one limitation or disadvantage of the existing art. Additional features and advantages of the present disclosure will be set forth and in part will be apparent from this description, or may be learned by the practice of the present disclosure.

### DESCRIPTION

The present disclosure is generally directed to tri-part calcium fortified compositions and methods for making the same. Although the present disclosure is applicable to and contemplates numerous compositions, for the sake of illustration, the following description focuses on exemplary embodiments of such a composition being a beverage. It, however, is recognized that the present disclosure is not limited to such embodiments, and rather can also be used for various other compositions such as food stuff, as described below.

As embodied and broadly described herein, the compositions of the present disclosure are capable of delivering a nutritionally significant amount of calcium per serving by including, as the added source of calcium, a combination consisting essentially of tricalcium phosphate, monocalcium phosphate, and calcium lactate. The composition of the present disclosure may be in a form chosen from an edible food product, such as, a solid or semi-solid food stuff, and a beverage, such as, water or fruit and vegetable juices and drinks, sport beverages, beverages employed to restore electrolytes lost through diarrhea and/or physical activity, carbonated beverages such as seltzer waters, soft drinks or mineral drinks, milk obtained from cows or plants (e.g., soy) or synthetic milk, and so called “botanical flavor” drinks such as cola and other naturally flavored drinks. The beverage of the present disclosure may be further chosen from a single strength beverage, a concentrated beverage that can be reconstituted using appropriate liquids, a dry mix beverage that can be reconstituted using appropriate liquids, and a frozen concentrate beverage that can also be reconstituted using appropriate liquids.

Calcium Source

Tricalcium phosphate (TCP) displays a number of characteristics rendering it suitable for use in the present invention. For example, the salt contains a significant percentage of calcium that allows for lower overall concentration in the beverages. Lower concentrations reduce costs, improve functionality and reduce the likelihood of imparting taste defects. TCP does not introduce flavor defects, but if used alone will reduce flavor perception by reducing the titratable acidity of the beverage. It is well known that acidity provides a flavor lift or increased perception of flavor in a beverage. The pKa values for the three protons in phosphoric acid are 2.15, 7.10 and 12.32. When the tricalcium salt of phosphoric acid is introduced into, e.g., orange juice with a pH of approximately 3.8, two calcium atoms representing pK₂ and pK₃ will exchange for two protons from primarily citric acid. The net effect is a neutralization of acidity with a resulting decrease in flavor perception. If TCP were the only calcium fortificant, then the resulting taste of the beverage would be described as bland, flat and possibly insipid. This problem can be further exaggerated when the beverage contains a particular juice (e.g., orange juice) with naturally fluctuating levels of fruit acid. In periods of lower acidity in the fruit, any additional reduction of acid via neutralization can result in a loss of flavor perception.

For example, in the past ten years in the state of Florida, climatic and other conditions, such as horticultural practices, resulted in some of the lowest acidity levels in citrus fruit as compared to the last fifty years of citrus production. These low acid levels have created additional challenges for manufacturing high quality, e.g., orange juice and fortified juice products.

As used herein, “tricalcium phosphate” includes either the salt or inorganic acid form of phosphoric acid and has the simple formula Ca₃(PO₄)₂. As defined in the Food Chemicals Codex, tricalcium phosphate is a variable mixture of calcium phosphates, having the approximate composition 10CaO.3P₂O₅.H₂O. This composition corresponds to the formula Ca₅(OH)(PO₄)₃ or Ca₁₀(OH)₂(PO₄)₆. Tricalcium phosphate is also known as tribasic calcium phosphate or tricalcium orthophosphate. Generally, tricalcium phosphate provides an assayed calcium content ranging from 34.0% to 40.0% by weight, such as about 38% by weight. Accordingly, tricalcium phosphate salt may be used as part of the calcium source in the present disclosure.

The amount of calcium contained in the compositions of the present disclosure may be limited by the solubility of the calcium combination, i.e., tricalcium phosphate, monocalcium phosphate, and calcium lactate, and/or the interactions of the salts with the beverage. The quantity of calcium used provides a nutritionally significant amount of calcium, meaning, the present disclosure provides for at least 10% of the U.S. RDI of calcium per serving of the beverage composition, e.g., about 100 mg of calcium/8 oz. up to about 50% of the RDI or 500 mg of calcium/8 oz. In one embodiment, the calcium combination is present in an amount that yields a single strength beverage composition comprising from 350 mg to 500 mg of calcium per 8 fl. ounces.

For example, the amount of tricalcium phosphate contained in the composition of the present disclosure is an amount sufficient to provide from 50% to 70% of the delivered calcium from the composition. In one embodiment, tricalcium phosphate provides 60% of the delivered calcium from the beverage composition.

Moreover, tricalcium phosphate may be present in the composition in an amount ranging from 0.01% to 5%, such as from 0.01% to 1.0%, and further for example, from 0.05% to 0.25% by weight, relative to the total weight of the composition.

The monocalcium salt of phosphoric acid may not neutralize naturally occurring fruit acid, as does the tricalcium salt. Instead, monocalcium phosphate increases the acidity of the composition. Monocalcium phosphate may be used to counterbalance the neutralization effect contributed to the composition by the tricalcium phosphate. The monocalcium phosphate component provides an assayed calcium content ranging from 15% to 20% by weight, such as about 16% by weight. Thus, regardless of the natural acidity contributed to the composition by the juice component, the addition of monocalcium phosphate may contribute to an increased acidity based simply on its concentration in the composition.

As used herein, “monocalcium phosphate” includes the anhydrous and monohydrate forms and blends, the salt or inorganic acid form of phosphoric acid, and mixtures thereof, and has a general formula of CaH₄(PO₄)₂.H₂O. In one embodiment of the present disclosure, monocalcium phosphate monohydrate is used in the calcium combination.

The amount of monocalcium phosphate contained in the beverage composition of the present disclosure is an amount sufficient to provide from 10% to 30% of the delivered calcium from the composition. For example, monocalcium phosphate provides 20% of the delivered calcium from the composition.

Moreover, monocalcium phosphate may be present in the composition in an amount ranging from 0.01 % to 5%, such as from 0.01% to 1.0%, and further for example, from 0.05% to 0.25%, by weight, relative to the total weight of the composition.

Calcium lactate is the final component in the calcium combination of the compositions of the present disclosure. It is known that calcium lactate may impart a bland taste in fruit juice, and that it may impart a bitter taste at high concentrations. Calcium lactate is also known to have good solubility properties and to impart a stabilizing effect when combined with other calcium salts. Calcium lactate provides an assayed calcium content ranging from 10% to 20% by weight, such as about 13% by weight.

As used herein, the term “calcium lactate” includes the pentahydrate and anhydrous forms and has a general formula of C₆H₁₀CaO₆.5H₂O. In one embodiment, the present disclosure utilizes calcium lactate pentahydrate.

The amount of calcium lactate contained in the compositions of the present disclosure is an amount sufficient to provide from 10% to 30% of the delivered calcium from the composition. For example, calcium lactate provides 20% of the delivered calcium from the composition.

Moreover, calcium lactate may be present in the composition in an amount ranging from 0.01% to 5%, such as from 0.01% to 1.0%, and further for example, from 0.05% to 0.25%, by weight, relative to the total composition.

The flavor of orange juice, for example, can be characterized by a unique balance of sweetness resulting from the sugar content and tartness resulting from the acid content. A challenge of fortifying orange juice with nutritionally significant amounts of calcium is maintaining the sweet to tart balance. This balance can be expressed analytically as the Brix to acid ratio, as described above. The Brix component of the ratio is the measure of soluble solids in the beverage often determined by a refractometer. The acid component can be determined by titration with a base such as sodium hydroxide. The Brix to acid ratio is an analytical representation or measure of the sweet to tart taste balance.

For example, research into the flavor of orange juice demonstrates that consumers have a preference for an optimum range of Brix-acid ratio. A ratio may range from about 17 to about 22 and span the optimum for most consumers, as indicated in Table I. As previously discussed, calcium salts can upset the balance of sweetness and acidity based on a number of factors including concentration of the salt, acidity constants of the corresponding acids, pH of the composition, buffering capacity of the salt, and fluctuating levels of naturally occurring fruit acids. The presently disclosed composition takes into consideration at least these factors and provides nutritionally significant levels of calcium, while maintaining the natural balance of sweetness and tartness to impart a clean and refreshing taste and texture similar in character to the unfortified juice.

An evaluation of the influence of individual calcium salts or salt complexes, such as calcium gluconate-lactate, at two different concentrations of calcium on orange juice was undertaken and is reported in Tables II and III. The results in Table II are for orange juice fortified at a calcium level between approximately 450 and 500 mg of calcium per 8 fl. ounces, while the results in Table III are for orange juice fortified with calcium between approximately 350 and 400 mg per 8 fl. ounces. This data demonstrates the large influence of the calcium salt on the Brix-acid ratio.

For example, from a starting Brix-acid ratio of 18.3 in the unfortified juice, the resulting ratio in the fortified juice can range from a low of 10.4, using monocalcium phosphate, to a high of 125.7, using calcium carbonate. A challenge, for instance, to those working in the fortification field is to find a calcium salt or system of salts that does not interrupt the natural delicate balance of taste and flavor factors that make up the complex sensory experience of, for example, drinking orange juice or other juice and juice drink beverages. The present composition, as disclosed herein, allows for such an experience.

With the information gained from the study of individual salts or salt complexes, an additional evaluation of salt systems was undertaken, as provided in Tables IV and V. This evaluation included measuring the influence on the Brix-acid ratio across a range of calcium combinations (Table IV) and determining consumer acceptance of the resulting juice (Table V). The results from Table IV show the considerable influence of a calcium system on the titratable acidity of the juice and subsequently, the Brix-acid ratio. The results of Table V show the effect of different calcium systems on consumer acceptance of orange juice.

As mentioned above, the Brix-acid ratio is at least one accepted measurement of the sweetness to tartness ratio used in the fruit juice industry. A calcium fortified beverage of the present disclosure can have a Brix-acid ratio in the range of about 5:1 to about 54:1, such as about 7:1 to 20:1 for citrus products.

According to the present disclosure, beverages of the present invention have a pH value, which does not exceed 4.5 when reconstituted, i.e., in a single strength form. For example, the beverage may have a pH value ranging from 2.5 to 4.5, and further for example, ranging from 2.7 to 3.5. The pH range given is typical for juice beverage products. A beverage having these characteristics, e.g., Brix-acid ratio and pH values, contributes to the distinct pleasant aftertaste and minimized flavor defects of the composition.

Juice

As used herein, the term “juice” has a meaning ascribed to it by a person of ordinary skill in the art and includes a full strength juice, a juice drink containing less than 100% juice, a concentrate of juice or drink, and a diluted juice from fruits and vegetables and other produce, which can be squeezed and/or crushed to produce a juice. For example, mention may be made of fruit juice and fruit flavors such as citrus juices and citrus drinks including orange, lemon, lime, tangerine, mandarin and grapefruit; grape; pear; passion fruit; pineapple; banana; banana puree; apple; cranberry; cherry; raspberry; peach; plum; currant; cranberry; blackberry; strawberry; Mirabelle; watermelon; honeydew; cantaloupe; mango; papaya; botanical flavors such as flavors derived from cola, tea, coffee, chocolate, vanilla and almond; vegetable juices; vegetable drinks; and flavors such as tomato, cabbages, celery, cucumber, spinach, carrot, lettuce, watercress, dandelion, rhubarb, beet, cocoa, guava, han guo, and mixtures thereof. Citrus juices such as orange, grapefruit, lemon, lime, and mandarin may be used in some of the embodiments of the presently disclosed composition, e.g., beverages.

The juice may be prepared from any known juice extraction process. For example, a typical orange juice extraction process comprises mechanically squeezing the fruit, e.g., oranges. During this process, the rag and seeds are removed and optionally, the remaining mixture of pulp and juice may be clarified by using a finisher. The finisher can separate the pulp from the juice by devices known in the art. The pulp removed may be recovered and used as floating pulp. On the other hand, the juice stream may contain sinking pulp and/or sinking solids that can be processed by the finisher sieve. It is at this time that the juice may be pasteurized utilizing known techniques in the art.

The juice may be in a form chosen from liquid, solid, and mixtures thereof depending on whether the composition is a ready-to-drink beverage, a concentrate or a dry mix, etc.

The juice component of the present disclosure comprises from 0.1% to 99.9% by weight of juice, and further for example, from 15% to 99.5% by weight, relative to the total weight of the composition. The juice may be in a form chosen from puree, comminute, single strength, and concentrated juice. A skilled artisan can determine the weight percent of the juice based on the type and form of juice, and any other considerations known to one skilled in the art.

According to one embodiment of the present disclosure, the composition may further comprise water. This water may be deemed “treated water”, “purified water”, “demineralized water”, and/or “distilled water.” In any event, the water should be suitable for human consumption and the composition is not, or not substantially detrimentally affected by the inclusion of the water.

Additional Additives

The composition according to the present disclosure may further comprise at least one additional additive. Mention may be made, for example, of acidulants, i.e., edible acids, flavor components, antifoaming agents, colorants, preservatives, sweeteners, vitamins and minerals, fibers, sterols and stanols, thickeners, i.e., viscosity modifiers and bodying agents, antioxidants, emulsifying agents, carbonation, bracers, and mixtures thereof. The composition may further comprise any other functional health ingredient, as well as ingredients typically used as optional beverage ingredients. Of course, a skilled artisan in the art will take care to choose this or these optional additional additives so that the advantageous properties intrinsically attached to the composition, e.g., beverage, in accordance with the present disclosure are not, or not substantially detrimentally affected by the envisaged addition.

Moreover, the amounts of these various additives, which may be present in the composition according to the present disclosure, are those conventionally used in food compositions, e.g., beverages.

Mention may be made, among acidulants, i.e., organic as well as inorganic edible acids, of potassium or sodium hydrogen phosphate, potassium or sodium dihydrogen phosphate salts. The acidulants may be present in their undissociated form or, alternatively, as their respective salts. For example, mention may be made of citric acid, malic acid, fumaric acid, adipic acid, phosphoric acid, gluconic acid, tartaric acid, ascorbic acid, acetic acid, phosphoric acid or mixtures thereof. The use of an edible acid may be based on the acid's efficacy on the calcium combination, and effects on the composition such as pH, titratable acidity, and taste.

Mention may be made, among flavor components, of oils, extracts, oleoresins, essential oils, and any other flavor component known in the art for use as flavorants in, e.g., beverages. For example, suitable flavors include but are not limited to fruit flavors, cola flavors, tea flavors, coffee flavors, chocolate flavors, diary flavors, and mixtures thereof. These flavors may be derived from natural sources such as essential oils and extracts, or may be synthetically prepared. Moreover, the flavors may be a blend of various flavors.

Mention may be made, among antifoaming agents, of dimethyl polysiloxane, distilled monoglycerides, medium chain triglycerides, polyglycerol esters, and mixtures thereof.

The composition of the present disclosure may also comprise colorants. Mention may be made, among colorants, of FD&C dyes, FD&C lakes, and mixtures thereof. Any other colorant used in food and/or beverages may be used. For example, a mixture of FD&C dyes or a FD&C lake dye in combination with other conventional food and food colorants may be used. Moreover, other natural coloring agents may be utilized including, for example, fruit, vegetable, and/or plant extracts such as grape, black currant, aronia, carrot, beetroot, red cabbage, and hibiscus.

As used herein, the term “preservative” includes all preservatives approved for use in food and/or beverage compositions such as chemical preservatives (e.g., benzoates, sorbates, and citrates), polyphosphates (e.g., sodium hexametaphosphate), antioxidants (e.g., ethylenediaminetetraacetic acid (EDTA)), and mixtures thereof. The at least one preservative may be present in an amount not exceeding maximum mandated levels, as established by the U.S. Food and Drug Administration. Moreover, preservatives may not be necessary for use in the present composition. Techniques known in the art, e.g., aseptic and/or hot-fill processing, may be utilized to ensure preservation versus the addition of known preservatives.

The compositions of the present disclosure may comprise an artificial or natural, caloric or noncaloric sweetener. Mention may be made, among sweeteners, of corn syrup solids, glucose, fructose, sucrose, invert sugars and mixtures thereof, and artificial sweeteners such as sucralose, saccharin, acesulfame-K, cyclamates, aspartame, and mixtures thereof. For example, high fructose corn syrup (HFCS) is commercially available as HFCS-42, HFCS-55 and HFCS-90 comprising, respectively, 42%, 55% and 90% by weight of fructose.

Mention may be made, among vitamins, of vitamin A, one or more B-complex vitamins, riboflavin, niacin, pantothenic acid, pyridoxine, biotin, and the cobalam ins, vitamin C, vitamin D, vitamin E, folic acid, biotin and mixtures thereof. Mention may be made, among minerals besides calcium, of zinc, iron, magnesium, manganese, copper, iodine, fluoride, selenium, and mixtures thereof. The addition of optional vitamins and minerals should be done with such care that the flavor provided through the use of the calcium combination is not significantly diminished.

Mention may be made, among thickeners, i.e., viscosity modifiers and/or bodying agents, of cellulose compounds, gum ghatti, modified gum ghatti, guar gum, gum tragacanth, gum Arabic, pectin, xanthum gum, carrageenan, locust gum, pectin, and mixtures thereof.

Mention may be made, among antioxidants, of ascorbic acid, EDTA, and salts thereof, gum guaic, propylgalacte, sulfite and metabisulfite salts, thiodiproprionic acid and esters, and mixtures thereof.

Any suitable food grade emulsifier may be used to stabilize the fat or oil clouding agent as an oil-in-water emulsion. This beverage emulsion can be either a cloud emulsion or a flavor emulsion.

For cloud emulsions, the clouding agent can comprise one or more fats or oils stabilized as an oil-in-water emulsion using a suitable food grade emulsifier. Any of a variety of fats or oils may be employed as the clouding agent, provided that the fat or oil is suitable for use in foods and/or beverages. Any suitable food grade emulsifier can be used that can stabilize the fat or oil clouding agent as an oil-in-water emulsion. Suitable emulsifiers may include gum acacia, modified food starches (e.g., alkenylsuccinate modified food starches), anionic polymers derived from cellulose (e.g., carboxymethylcellulose), gum ghatti, modified gum ghatti, xanthan gum, tragacanth gum, guar gum, locust bean gum, pectin, and mixtures thereof.

Flavor emulsions useful in the compositions, e.g., beverages, of the present invention comprise at least one suitable flavor oil, extract, oleoresin, essential oil and the like, known in the art for use as flavorants in beverages.

Carbonation may be further added to the present disclosure based on techniques commonly known to the skilled artisan. For example, carbon dioxide may be added to the water introduced into the beverage or beverage concentrate.

Bracers may also be added to the present composition, which may be obtained by extraction from a natural source or synthetically produced. Non-limiting examples of bracers include methylxanthines, e.g., caffeine, theobromine, and theophylline.

Methods of Use

A method of fortifying a beverage of the present disclosure comprises preparing a calcium combination consisting essentially of tricalcium phosphate, monocalcium phosphate and calcium lactate; and combining the calcium combination and a juice. This method may also be useful for balancing sweetness and tartness associated with juices in a composition, e.g., a beverage, and for reducing and/or eliminating flavor defects associated with calcium fortification of a composition, e.g., a beverage.

In one embodiment, preparation of the composition of the present disclosure comprises determination of the U.S. RDI level of calcium desired; addition of the calcium salt blend to water; vigorous agitation of the solution of salt blend and water until partial solubility of the salt blend in water is achieved; addition of the calcium salt blend to pre-blended juice concentrate and flavoring components and continued agitation until the salt blend is completely dispersed. Alternatively, if fresh, single strength juice is to be combined, the salt therein can be mixed with a portion of the fresh juice and then, following continued agitation, the remaining portion may be added. Other known methods useful for forming beverage compositions may be used to make the beverage compositions comprising the disclosed calcium combination.

Other than in the operating examples, or where otherwise indicated, all numbers expressing quantities of ingredients, composition conditions, and so forth used in the specification and claims are to be understood as being modified in all instances by the term “about.” Accordingly, unless indicated to the contrary, the numerical parameters set forth in this specification and attached claims are approximations that may vary depending upon the desired properties sought to be obtained by the present disclosure. At the very least, with respect to the specification and the claims, each numerical parameter should be construed in light of the number of significant digits and ordinary rounding approaches.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

### EXAMPLES

### Example I

### Brix-Acid Ratio Study

Calcium fortified orange juices were evaluated based on various Brix-acid ratios for consumer acceptance to determine if there was a correlation between consumer acceptance and the Brix-acid ratio of the beverage. Consumer acceptance was evaluated on a 9-point Hedonic scale. The Hedonic scale is a subjective means to evaluate the overall acceptability of the beverage composition based upon a combination of sensory attributes, i.e., taste, smell, mouth feel, and appearance. These attributes are used to grade how the beverage composition of the present disclosure is expected to taste, smell, feel, and appear. On the 9-point Hedonic scale, a beverage composition is acceptable if, on average, the composition's Hedonic score is 5 or greater. The following descriptions correspond with the points on the scale: 1 is “dislike extremely”, 2 is “dislike very much”, 3 is “dislike moderately”, 4 is “dislike slightly”, 5 is “neither like nor dislike”, 6 is “like slightly”, 7 is “like moderately”, 8 is “like very much”, and 9 is “like extremely.”

In this evaluation, the consumers comprised a sufficiently large number to provide a statistically valid result with a confidence level of 95%. As provided below, the medium ratio orange juice with a Brix-acid ratio of 20.5 scored the highest consumer acceptable value with a 6.8 on the Hedonic scale and further provided that consumer acceptance is correlated, in part, with the Brix-acid ratio.

TABLE I

| Calcium | | Titratable | | Brix- | | |
|---|---|---|---|---|---|---|
| Fortified Orange | Calcium | Acidity | | Acid | Consumer | |
| Juice (OJ) | Load¹ | (%) | Brix | Ratio | Acceptance² | |
| Low Ratio OJ | 350 | 0.75 | 12.56 | 16.7 | 6.2 | B |
| Medium Ratio OJ | 350 | 0.621 | 12.71 | 20.5 | 6.8 | A |
| High Ratio OJ | 350 | 0.498 | 12.53 | 25.2 | 6.4 | B |

¹mg calcium per 8 oz.
²Samples with different letters are significantly different at the 95% confidence level, i.e., designated with the letters “A” and “B” after the consumer acceptance level.

### Example II

### Calcium Salts—Physical/Chemical Attributes in Orange Juice

A. 450 mg/100 mL Calcium Load

A variety of calcium salts, i.e., the calcium components, were evaluated to determine their effects on the Brix-acid ratio. In this evaluation, orange juices fortified with different calcium salts were prepared at 450 mg/100 mL of calcium load. Table II summarizes the results.

TABLE II

| | | Calcium - | | Titratable | | |
|---|---|---|---|---|---|---|
| | % Calcium | Juice | pH | Acidity (%) | Brix | Brix/Acid |
| Calcium Source | in Source | (48 Hours) | (48 Hours) | (48 Hours) | (48 Hours) | Ratio |
| Unfortified Orange Juice | NA | 14 | 3.94 | 0.647 | 11.85 | 18.3 |
| calcium ascorbate dihydrate | 9.4 | 195 | 4.23 | 0.648 | 13.99 | 21.6 |
| calcium lactate pentahydrate | 13.0 | 204 | 4.03 | 0.657 | 13.01 | 19.8 |
| calcium chloride dihydrate | 27.3 | 206 | 3.84 | 0.620 | 12.70 | 20.5 |
| calcium fumarate trihydrate | 19.0 | 202 | 4.01 | 0.659 | 12.96 | 19.7 |
| calcium L-glutamate tetrahydrate | 9.9 | 207 | 4.47 | 0.627 | 13.81 | 22.0 |
| calcium lactate gluconate citrate | 12.4 | 200 | 4.05 | 0.694 | 13.27 | 19.1 |
| calcium aspartate | 12.8 | 187 | 4.28 | 0.610 | 13.42 | 22.0 |
| calcium gluconate/lactate | 12.7 | 205 | 4.01 | 0.650 | 13.28 | 20.4 |
| calcium gluconate/lactate | 10.5 | 199 | 4.04 | 0.645 | 13.47 | 20.9 |
| calcium carbonate | 40.0 | 200 | 5.88 | 0.099 | 12.44 | 125.7 |
| calcium succinate monohydrate | 23.0 | 206 | 4.66 | 0.607 | 12.85 | 21.2 |
| calcium formate | 30.8 | 206 | 4.20 | 0.620 | 12.59 | 20.3 |
| calcium lactate gluconate citrate | 13.6 | 202 | 4.11 | 0.655 | 13.18 | 20.1 |
| monocalcium phosphate monohydrate | 16.0 | 207 | 3.69 | 1.238 | 12.92 | 10.4 |
| calcium glycerophosphate monohydrate | 19.1 | 187 | 4.50 | 0.598 | 12.73 | 21.3 |
| calcium gluconate monohydrate | 8.9 | 198 | 4.00 | 0.653 | 13.91 | 21.3 |
| dicalcium phosphate dihydrate | 23.3 | 181 | 4.21 | 0.682 | 12.26 | 18.0 |
| dicalcium phosphate anhydrous | 29.5 | 203 | 4.04 | 0.674 | 12.04 | 17.8 |
| calcium malate | 20.0 | 213 | 4.17 | 0.641 | 12.80 | 20.0 |
| tricalcium phosphate | 38.0 | 182 | 4.37 | 0.561 | 12.40 | 22.1 |
| tricalcium phosphate (fine) | 38.0 | 197 | 4.51 | 0.484 | 12.30 | 25.4 |
| tri-calcium citrate | 24.1 | 177 | 4.07 | 0.630 | 12.08 | 19.2 |
| calcium L-tartrate dihydrate | 17.9 | 140 | 4.23 | 0.545 | 12.02 | 22.1 |

B. 350 mg/100 mL Calcium Load

A variety of calcium salts, i.e., calcium components, were again evaluated to determine their effects on the Brix-acid ratio but this time at 350 mg/100 mL calcium load. Table III summarizes the results.

From the calcium loads at 350 mg/100 mL and 450 mg/100 mL in Tables II and III, when equivalent amounts of calcium are added, generally different calcium components modify the juice component in different ways. For example, the different calcium components as well as the calcium load can influence the pH, titratable acidity, Brix value and ultimately, the Brix/Acid ratio of the juice component. These data suggest that a calcium component or for that matter a combination of calcium components can more or less alter intrinsic parameters of an unfortified juice.

TABLE III

| | | Calcium in | | Titratable | | |
|---|---|---|---|---|---|---|
| | % Calcium | Juice | pH | Acidity (%) | Brix | Brix/Acid |
| Calcium Source | in Source | (48 hrs) | (48 hrs) | (48 hrs) | (48 hrs) | Ratio |
| Unfortified Orange Juice | NA | 14 | 3.94 | 0.647 | 11.85 | 18.3 |
| calcium gluconate monohydrate | 8.9 | 154 | 3.99 | 0.640 | 13.56 | 21.2 |
| calcium lactate pentahydrate | 13.0 | 157 | 4.01 | 0.670 | 12.80 | 19.1 |
| gluconate/lactate | 10.5 | 158 | 4.01 | 0.640 | 13.11 | 20.5 |
| calcium lactate gluconate citrate | 12.4 | 157 | 4.03 | 0.688 | 13.01 | 18.9 |
| calcium fumarate trihydrate | 19.0 | 158 | 3.99 | 0.643 | 13.56 | 21.1 |
| calcium glycerophosphate monohydrate | 19.1 | 145 | 4.42 | 0.602 | 12.54 | 20.8 |
| calcium formate | 30.8 | 160 | 4.18 | 0.620 | 12.45 | 20.1 |
| calcium chloride dihydrate | 27.3 | 163 | 3.88 | 0.618 | 12.54 | 20.3 |
| calcium gluconate/lactate | 12.7 | 158 | 4.00 | 0.641 | 13.01 | 20.3 |
| calcium lactate gluconate citrate | 13.6 | 161 | 4.08 | 0.641 | 12.95 | 20.2 |
| calcium carbonate | 40.0 | 158 | 5.15 | 0.188 | 12.35 | 65.7 |
| calcium L-glutamate tetrahydrate | 9.9 | 161 | 4.42 | 0.621 | 13.41 | 21.6 |
| calcium ascorbate dihydrate | 9.4 | 160 | 4.16 | 0.618 | 13.41 | 21.7 |
| monocalcium phosphate monohydrate | 16.0 | 164 | 3.76 | 1.083 | 12.53 | 11.6 |
| dicalcium phosphate dihydrate | 23.3 | 141 | 4.17 | 0.667 | 12.33 | 18.5 |
| dicalcium phosphate anhydrous | 29.5 | 156 | 4.04 | 0.677 | 11.97 | 17.6 |
| calcium succinate monohydrate | 23.0 | 161 | 4.56 | 0.606 | 12.64 | 20.9 |
| calcium malate | 20.0 | 166 | 4.15 | 0.635 | 12.54 | 19.7 |
| calcium aspartate | 12.8 | 159 | 4.24 | 0.617 | 13.11 | 21.2 |
| tricalcium phosphate | 38.0 | 147 | 4.34 | 0.530 | 12.39 | 23.4 |
| tricalcium phosphate (fine) | 38.0 | 157 | 4.49 | 0.490 | 12.27 | 25.0 |
| tri-calcium citrate | 24.1 | 140 | 4.06 | 0.640 | 12.37 | 19.3 |
| calcium L-tartrate dihydrate | 17.9 | 113 | 4.17 | 0.574 | 11.99 | 20.9 |

Calcium concentration in mg/100 mL

### Example III

### Blends of Calcium Salts—Physical/Chemical Attributes in Orange Juice

Orange juices fortified with various combinations of calcium salts, i.e. calcium components, were evaluated based on physical/chemical attributes compared to unfortified orange juice. Table IV summaries the results.

As demonstrated in Table IV, various combinations of calcium components exhibited different results with respect to pH, titratable acidity, Brix value and Brix/Acid ratio. For example, the calcium combination of tricalcium phosphate, monocalcium phosphate monohydrate and calcium lactate, and the calcium combination of dicalcium phosphate anhydrous and calcium lactate exhibited Brix/Acid ratios substantially similar to the unfortified orange juice as compared with other calcium salt combinations. Thus, based on these tested parameters, these calcium combinations are comparable to an unfortified orange juice and thus, making it acceptable and/or desirable to fortify an unfortified juice with these calcium combinations.

TABLE IV

| | | Calcium - | | Titratable | | |
|---|---|---|---|---|---|---|
| Calcium Source | Calcium | Juice | pH | Acidity (%) | Brix | Brix/Acid |
| (% Ca contributed) | Load¹ | (1 wk) | (1 wk) | (1 wk) | (1 wk) | Ratio |
| Unfortified Orange Juice FC | 0 | 15 | 3.8 | 0.743 | 11.84 | 15.9 |
| TCP(75), CL(25) | 350.0 | 151 | 4.19 | 0.613 | 12.50 | 20.4 |
| TCP(60), CL(20), MCPM(20) | 350.0 | 154 | 4.08 | 0.725 | 12.5 | 17.2 |
| DCPA(75), CL(25) | 305.0 | 131 | 4.03 | 0.723 | 12.39 | 17.1 |
| Unfortified Orange Juice FC | 0.0 | 15 | 3.90 | 0.615 | 11.84 | 19.3 |
| TCP(75), CL(25) | 350.0 | 152 | 4.32 | 0.510 | 12.39 | 24.3 |
| TCP(60), CL(20), MCPM(20) | 350.0 | 151 | 4.19 | 0.613 | 12.43 | 20.3 |
| DCPA(75), CL(25) | 350.0 | 138 | 4.12 | 0.607 | 12.36 | 20.4 |
| Unfortified Orange Juice FC | 0.0 | 15 | 3.77 | 0.703 | 11.84 | 16.8 |
| DCPD(80), CL(20) | 400.0 | 174 | 4.06 | 0.741 | 12.53 | 16.9 |
| DCPD(85), MCPM(15) | 400.0 | 175 | 4.03 | 0.802 | 12.51 | 15.6 |
| Unfortified Orange Juice FC | 0.0 | 15 | 3.95 | 0.601 | 11.80 | 19.6 |
| DCPD(80), CL(20) | 400.0 | 175 | 4.20 | 0.654 | 12.48 | 19.1 |
| DCPD(85), MCPM(15) | 400.0 | 169 | 4.15 | 0.721 | 12.43 | 17.2 |

¹mg Ca per 8 oz.
Calcium concentration in mg/100 mL
TCP = tricalcium phosphate
CL = calcium lactate
MCPM = monocalcium phosphate monohydrate
DCPA = dicalcium phosphate anhydrous
DCPD = dicalcium phosphate dihydrate

### Example IV

### Blends of Calcium Salts Used in Consumer Tests

Calcium fortified orange juice with various calcium salt combinations forming a calcium combination were evaluated for consumer acceptance using the 9-point Hedonic scale, as discussed above. Table V summarizes the attributes of the beverages as well as the consumer acceptance value.

As shown in Table V, various calcium combinations exhibited different results with respect to pH, titratable acidity, Brix value and Brix/Acid ratio, which suggests that these indicators may predict, i.e., influence, the overall consumer acceptance. For example, the calcium combination of tricalcium phosphate, monocalcium phosphate and calcium lactate, and the calcium combination of dicalcium phosphate anhydrous and calcium lactate, which above were comparable to the unfortified orange juice based on the various calcium combinations evaluated, resulted in the highest consumer acceptance values.

TABLE V

| | | Calcium - | | Titratable | | | | |
|---|---|---|---|---|---|---|---|---|
| Calcium Source | Calcium | Juice | pH | Acidity (%) | Brix | Brix/Acid | Consumer | |
| (% Ca contributed) | Load¹ | (1 wk) | (1 wk) | (1 wk) | (1 wk) | Ratio | Acceptance² | |
| Test #1 | | | | | | | | |
| Unfortified Orange Juice FC | 0 | 15 | 3.9 | 0.615 | 11.8 | 19.2 | | |
| TCP(75), CL(25) | 350.0 | 155 | 4.24 | 0.521 | 12.54 | 24.1 | 6.7 | B |
| TCP(60), CL(20), MCPM(20) | 350.0 | 155 | 4.11 | 0.619 | 12.48 | 20.2 | 7.2 | A |
| Test#2 | | | | | | | | |
| Unfortified Orange Juice FC | 0.0 | 15 | | 0.740 | 11.90 | 16.1 | | |
| TCP(75), CL(25) | 350.0 | 151 | 4.19 | 0.613 | 12.50 | 20.4 | 7.0 | B |
| TCP(60), CL(20), MCPM(20) | 350.0 | 154 | 4.08 | 0.725 | 12.50 | 17.2 | 7.2 | AB |
| DCPA(75), CL(25) | 300.0 | 131 | 4.03 | 0.723 | 12.39 | 17.1 | 7.4 | A |
| Test#3 | | | | | | | | |
| Unfortified Orange Juice FC | 0.0 | | | 0.720 | 11.80 | 16.4 | | |
| TCP(75), CL(25) | 350.0 | 157 | 4.08 | 0.601 | 12.22 | 20.3 | 7.1 | A |
| DCPD(85), MCPM(15) | 350.0 | 158 | 3.99 | 0.826 | 12.32 | 14.9 | 6.7 | B |
| DCPD(80), CL(20) | 350.0 | 158 | 4.03 | 0.742 | 12.30 | 16.6 | 6.9 | A |
| Test#4 | | | | | | | | |
| Unfortified Orange Juice FC | 0.0 | | | 0.630 | 11.85 | 18.8 | | |
| TCP(75), CL(25) | 350.0 | 159 | 4.14 | 0.534 | 12.25 | 22.9 | 7.1 | A |
| DCPD(85), MCPM(15) | 350.0 | 149 | 4.08 | 0.734 | 12.33 | 16.8 | 6.7 | B |
| DCPD(80), CL(20) | 350.0 | 151 | 4.11 | 0.674 | 12.37 | 18.4 | 6.9 | AB |

¹mg Ca per 8 oz.
²Samples with different letters are significantly different at the 95% confidence level.
Ca concentration in mg/100 mL

A calcium fortified composition manufactured in accordance with the present invention exhibits a good balance of solids distribution in addition to not significantly affecting the indigenous nutrients present in juice by the calcium combination addition. The blend of tricalcium phosphate, monocalcium phosphate, calcium lactate and juice according to the disclosure may also essentially be free from harsh or bitter taste, effervescence during manufacture or when consumed, calcium salt precipitation, and calcium salt off flavor. In contrast, blends of other calcium salts and juice usually exhibit such undesirable qualities and produce the characteristic bitter off note of a calcium salt taste. The characteristic sharp, clean, fruity, taste of the beverage according to the disclosure is, therefore, surprising. In one embodiment, it is also characteristic of the calcium-fortified composition of the present disclosure that the salt blend does not markedly increase sedimentation in spite of the well-known phenomenon of calcium-citrate precipitation. Examples V-IX set forth below exemplify compositions of other forms of the calcium-fortified product of the present disclosure, but are not intended to be limiting thereof.

### Example V

### Calcium Fortified 100% Juice from Concentrate

A beverage composition comprising a calcium combination according to the present disclosure was prepared by combining the following ingredients to a final volume of 1000 gallons with water:

1593.0 lbs of orange concentrate, 65° Brix

50.0 lbs of pulp

25.0 lbs. of flavors

19.7 lbs of tricalcium phosphate

15.3 lbs of monocalcium phosphate monohydrate

17.5 lbs of calcium lactate

### Example VI

### Calcium Fortified 100% Juice Not from Concentrate

A beverage composition comprising a calcium combination according to the disclosure was prepared by combining the following ingredients to a final volume of 1000 gallons with water:

8691.0 lbs of not-from-concentrate juice, 12° Brix

19.7 lbs. of tricalcium phosphate

15.3 lbs of monocalcium phosphate monohydrate

17.5 lbs of calcium lactate

### Example VII

### Calcium Fortified Juice Drink, Ready-to-Serve

A beverage composition comprising a calcium combination according to the disclosure was prepared by combining the following ingredients to a final volume of 1000 gallons with water:

79.9 lbs of orange juice concentrate, 65° Brix

28.9 lbs of citric acid

1.3 lbs of coloring

999.4 lbs of HFCS-55 (High Fructose Corn Syrup with 55% fructose), 77° Brix

10.0 lbs of flavors

5.62 lbs of tricalcium phosphate

4.36 lbs of monocalcium phosphate monohydrate

5.02 lbs of calcium lactate

### Example VIII

### Calcium Fortified Juice Drink, Ready-to-Serve

A beverage composition comprising a calcium combination according to the disclosure was prepared by combining the following ingredients to a final volume of 1000 gallons with water:

440.58 lbs of not from concentrate juice, 12° Brix

29.4 lbs of citric acid

1.3 lbs of coloring

997.6 lbs of HFCS-55 (High Fructose Corn Syrup with 55% fructose), 77° Brix

10.0 lbs of flavors

5.62 lbs of tricalcium phosphate

4.36 lbs of monocalcium phosphate monohydrate

5.02 lbs of calcium lactate

### Example IX

### Calcium Fortified 100% Juice Concentrate

A beverage composition comprising a calcium combination according to the disclosure was prepared by combining the following ingredients to a final volume of 1000 gallons with water:

6364.6 lbs of orange concentrate, 65° Brix

269.0 lbs of pulp

298.3 lbs of flavors

76.0 lbs of tricalcium phosphate

60.0 lbs of monocalcium phosphate monohydrate

71.6 lbs of calcium lactate

It is intended that the specification and examples be considered as exemplary only, with the true scope and spirit of the present disclosure being indicated by the claims.

What is claimed is:

1. A composition comprising (a) a calcium combination consisting essentially of tricalcium phosphate, monocalcium phosphate and calcium lactate, and (b) a juice.

2. The composition according to claim 1, wherein the composition is in a form chosen from an edible food product and a beverage.

3. The composition according to claim 2, wherein the form comprises a beverage.

4. The composition according to claim 1, wherein the tricalcium phosphate is present in an amount ranging from 50% to 70% by weight of total calcium, the monocalcium phosphate is present in an amount ranging from 10% to 30% by weight of total calcium and the calcium lactate is present in an amount ranging from 10% to 30% by weight of total calcium.

5. The composition according to claim 1, further comprising water.

6. The composition according to claim 1, further comprising at least one additive.

7. The composition according to claim 6, wherein the at least one additive is chosen from acidulants, flavor components, antifoaming agents, colorants, preservatives, sweeteners, vitamins and minerals, fibers, sterols and stanols, thickeners, antioxidants, emulsifying agents, carbonation, bracers, and mixtures thereof.

8. A beverage comprising (a) a calcium combination consisting essentially of tricalcium phosphate, monocalcium phosphate and calcium lactate, and (b) a juice.

9. The beverage according to claim 8, wherein the monocalcium phosphate is monocalcium phosphate monohydrate.

10. The beverage according to claim 8, wherein the calcium lactate is calcium lactate pentahydrate.

11. The beverage according to claim 8, wherein the beverage is in a form chosen from a single strength beverage, a concentrate, and a dry mix.

12. The beverage according to claim 8, wherein the calcium combination is present in an amount that yields a single strength beverage comprising from 350 mg to 500 mg of calcium per 8 fluid ounces.

13. The beverage according to claim 8, wherein the beverage has a pH value of less than or equal to 4.5.

14. The beverage according to claim 8, wherein the juice is in a form chosen from liquid, solid, and mixtures thereof.

15. The beverage according to claim 8, wherein the juice is chosen from citrus juices, non-citrus fruit juices, vegetable juices, and mixtures thereof.

16. The beverage according to claim 15, wherein the juice comprises a citrus juice.

17. The beverage according to claim 8, wherein the juice is present in an amount ranging from 0.1% to 99.9% by weight relative to the total beverage.

18. The beverage according to claim 8, wherein the tricalcium phosphate is present in an amount ranging from 50% to 70% by weight of total calcium, the monocalcium phosphate is present in an amount ranging from 10% to 30% by weight of total calcium and the calcium lactate is present in an amount ranging from 10% to 30% by weight of total calcium.

19. The beverage according to claim 18, wherein the tricalcium phosphate is present in an amount comprising about 60% by weight of total calcium, monocalcium phosphate is present in an amount comprising about 20% by weight of total calcium, and calcium lactate is present in an amount comprising about 20% by weight of total calcium.

20. The beverage according to claim 8, wherein the juice exhibits a Brix-acid ratio ranging from 5:1 to 54:1.

21. The beverage according to claim 8, wherein the juice exhibits a Brix-acid ratio ranging from 12.5:1 to 20:1.

22. The beverage according to claim 8, further comprising water.

23. The beverage according to claim 8, further comprising at least one additive.

24. The beverage according to claim 23, wherein the at least one additive is chosen from acidulants, flavor components, antifoaming agents, colorants, preservatives, sweeteners, vitamins and minerals, fibers, sterols and stanols, thickeners, antioxidants, emulsifying agents, carbonation, bracers, and mixtures thereof.

25. A calcium fortified beverage product comprising (a) a calcium combination consisting essentially of tricalcium phosphate, monocalcium phosphate and calcium lactate, wherein about 60% by weight of total calcium added is supplied from tricalcium phosphate, about 20% by weight of total calcium added is supplied from monocalcium phosphate and about 20% by weight of total calcium added is supplied from calcium lactate and (b) a citrus juice.

26. A method of fortifying a beverage comprising:
preparing a calcium combination consisting essentially of tricalcium phosphate, monocalcium phosphate and calcium lactate; and
combining the calcium combination and a juice.

27. The method according to claim 26, wherein the tricalcium phosphate is present in an amount ranging from 50% to 70% by weight of total calcium, monocalcium phosphate is present in an amount ranging from 10% to 30% by weight of total calcium, and calcium lactate is present in an amount ranging from 10% to 30% by weight of total calcium.

28. A method for balancing sweetness and tartness associated with juices in a beverage comprising:
preparing a calcium combination consisting essentially of tricalcium phosphate, monocalcium phosphate and calcium lactate; and
combining the calcium combination and a juice.

29. A method for reducing and/or eliminating flavor defects associated with calcium fortification in a beverage comprising:
preparing a calcium combination consisting essentially of tricalcium phosphate, monocalcium phosphate and calcium lactate; and
combining the combination calcium component and a juice.
